(19) United States
(12) Patent Application Publication
(10) Pub. No.: US 2025/0259125 A1
(43) Pub. Date: Aug. 14, 2025

(54) Heuristic Risk Management System Using AI Recommendation Engine

(71) Applicant: KIMBERLY ROXANNE JOHNSON, New Orleans, LA (US)

(72) Inventor: KIMBERLY ROXANNE JOHNSON, New Orleans, LA (US)

(21) Appl. No.: 18/438,435

(22) Filed: Feb. 10, 2024

(51) Int. Cl. G06Q 10/0635

(52) U.S. Cl. CPC G06Q 10/0635

(57) ABSTRACT

A heuristic risk management system for business and technical organizations that provides and augments monitoring, detection, assessment, and disposition to alleviate or reduce enterprise risk exposure. The risk management system monitors a user-defined set of features or attributes of the system. Based on a specification of risk levels for the defined features, the risk management system determines the risk posture (and potential exposure) of the enterprise. The use of heuristics is an approach to discover, learn, and problem-solve using rules, estimates, or educated guesses to find a satisfactory or optimal (and quantitative) solution. Conversely, qualitative risk management systems are limited in the interpretative use. The use of heuristics is a rigorous and objective method of quantifying risks at the organizational and enterprise level.

### BACKGROUND

### Field of the Invention

This present invention is directed to a heuristic risk management which takes the next, innovative, and evolutionary step in combining qualitative (such as interpretive techniques) and quantitative methods using Artificial Intelligence (AI) to offer an integrated look at an organization's overall risk posture.

### Description of the Related Art

Provide a brief description of the current state of the art. Modern risk management systems utilize qualitative methods to identify, analyze, and deposition risks. Qualitative risk management systems are limited in the interpretative use. Even best-in-class risk management systems that use qualitative means are highly susceptible to more subjective analysis and interpretation to the detriment to the organization. The use of heuristics is a rigorous and objective method of quantifying risks at the enterprise level.

### SUMMARY

In one embodiment of the present invention, the heuristic risk management systems using a recommendation system will expand the limited disclosure and utilization of modern risk management systems.

This risk management system can be used across disciplines and industry segments, and therefore, can be expand the use and understanding of organizational risk at the organizational and enterprise level.

### BRIEF DESCRIPTION OF THE DRAWINGS

FIG. 1. Pictorial Representation of Input/Output Flow for Heuristic Risk Management System Using Recommendation Engine

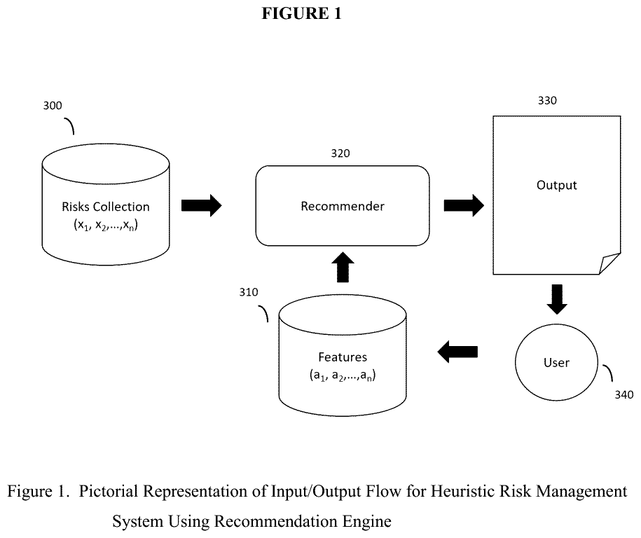

Risks (datasets) (310) are structured and are alphanumerical.

Input of datasets are labeled for features (310), which describe risk categories.

Risks (300) and Features (310) are tabulated in Recommender (330) for faster and more efficient processing, to determine the most suitable heuristic ranking in the Output (330) of risk to User (340).

### DETAILED DESCRIPTION

A Heuristic Risk Ranking Method Using Recommendation Engines is a novel and pioneering approach to Enterprise Risk Management. This invention, the process of defining, characterizing, and ranking enterprise risks, provides in-depth insights into operations and financials utilizing Artificial Intelligence (AI) (Recommendation Engines).

This system and method supersede modern risk management systems, which use qualitative methods to identify, analyze, and deposition risks.

Risks (300) and Features (310) are user-defined and inputted into Recommender (330) for processing. The Output (330) to the User (340) is a synthesis of risks characterized and ranked, determining organizational and enterprise risk posture.

1. This invention, the Heuristic Risk Management Systems Using Recommendation Engines, will allow for industry-agnostic implementation of heuristics in business and technical organizations and will give more procedural and financial fidelity to all phases of commerce, including development and operations.
